(19) United States
(12) Patent Application Publication
(10) Pub. No.: US 2006/0225596 A1
(43) Pub. Date: Oct. 12, 2006

(54) Process for digital printing for flexible packaging

(76) Inventors: Mikhail Laksin, Boonton, NJ (US); Subhankar Chatterjee, Hampton, NJ (US); Jean-Dominique Turgis, Vertou (FR); Wojciech A. Wilczak, Jersey City, NJ (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 11/100,713

(22) Filed: Apr. 7, 2005

(51) Int. Cl. B41N 1/00

(52) U.S. Cl. 101/491; 101/395

(57) ABSTRACT

A digital printing process is disclosed comprising transferring energy curable paste inks from a digital printing plate onto a substrate by wet trapping, wherein said digital printing plate comprises polymeric material covering the plate and collapsed in areas to form a non-image area on said plate.

### FIELD OF THE INVENTION

The present invention relates to printing process for flexible packaging.

### BACKGROUND OF THE INVENTION

CTP (computer to plate and computer to press) technology is the fastest growing segment of the printing market that is clearly going to dominate entire pre-press across the Graphic Art field. When CTP is applied to the offset plate, both—“to plate” and “to press” technology already exists. The best example of “to press” technology are Quickmaster D1, Karat etc. presses. In this case, waterless offset plates are used. Plate imaging step is short (less than 9 minutes for a set of 4 process colors on D1), because the plate's layer that has to be ablated does not typically exceed 1 micron. This technology is used in commercial printing and recently in news printing but not in flexible packaging. Selective wetting of the plate's image and non-image areas by the ink is a very sensitive and complex process that makes both litho and waterless offset printing very complicated. It is even more difficult to use offset printing on non-absorbent plastic substrates.

All these processes utilize conventional paste ink system that have limited adhesion to plastic substrates and don't meet most of the flexible packaging and end use requirements including chemical and abrasion resistance, low odor, low migration and regulatory compliance.

Ink Jet systems are said to be suitable for digital printing on flexible substrates. However, Ink jet printing is very slow (typically less than 100 fpm) and ink jet inks are lacking required fitness for use typically imposed on the flexible packaging inks. Also, UV curable ink jet inks are mostly made out of low viscosity and low functionality acrylated monomers that have very limited abrasion resistance, excessive odor and extractables.

Letterpress printing is much more robust because the image area is raised over the non-image area. Print quality of letterpress printing which utilizes higher viscosity paste inks is equal or better than offset printing, and this technology is very suitable for printing on flexible films or paper. Ko-Pack has a press designed for letterpress printing or flexible substrates with UV curable inks utilizing inter-station curing of individual colors. This requires a very complex press design that include individual UV lamps connected to an exhaust system and extensive cooling of the Central Impression Drum (CID) to compensate for an excessive heat generated by UV lamps. This significantly increases cost of the printing press.

### SUMMARY OF THE INVENTION

The present invention provides a digital printing process comprising transferring energy curable paste inks from a digital printing plate onto a substrate by wet trapping, wherein said digital printing plate comprises polymeric material covering the plate and collapsed in areas to form a non-image area on said plate.

Other objects and advantages of the present invention will become apparent from the following description and appended claims.

### DETAILED DESCRIPTION OF THE INVENTION

A novel printing process has been discovered and is recommended for flexible packaging materials, said process comprising: digital imaging of the flexible printing plate with raised image; wet trapping multicolor printing-process with energy curable paste inks; and instantaneous curing upon exposure to UV or EB irradiation.

Wet trapping is a process whereby the ink layer deposited or applied at each inking station is not dried before the next ink layer is deposited thereover to produce a coloristic or visual effect. More details about wet trapping techniques and inks are provided in U.S. Pat. No. 6,772,683 which is hereby incorporated by reference.

The plate material used in the present invention comprises a polymer film, preferably a micro-foamed polymer film containing at least 20% air by volume. Preferably, the polymeric film is selected from the group consisting of polyethylene, polypropylene, polystyrene, polyester, polyurethane, polycarbonate, polyvinyl chloride, epoxy, polyamide, polyamide, polyisocyanurate, polyacrylics, rubber, melamine and a blend thereof.

Upon exposure to irradiation such as IR laser beam, the polymer film rapidly collapses forming a cavity in the non-image area of the plate. The depth of the plate relief is controlled by the foam size, nature of the polymer, exposure time and laser power. Since polymer to foam ratio can be very small, the same or similar amount of IR energy and time that are needed to ablate a thin but hard ink receptive layer of the offset plate would cause a significant cavity in the foamed polymer film.

It is also beneficial to use heat sensitive polymers that would shrink at the high temperature of IR beam further increasing the depth of the plate relief. Any ink systems can be used with such plate, especially wet trappable EB curable paste inks which are the most suitable to meet many end use flexible packaging requirements.

The printing plate of the present invention allows a digital press and printing process design for the flexible packaging market with raised plated imaged directly on press in a very short time. Micro-foamed plate material is a key element of this technology, which allows an image to be sent directly to press, and the printing plate is generated in a very short time without causing a major press down time and printing a packaging material on selected substrate using energy curable inks that will be ready for shipment immediately after printing.

The proposed process will allow for the use of digital work flow in the plate making process, shorting cycle time of the pre-press. Simplified and less expensive printing press configuration without interstation curing or drying will be employed to print consecutive color from the digitally produced flexible plate with raised image using wet trappable UV or EB curable paste inks. Due to instantaneous cure upon exposure to UV or EB irradiation, printing speed is limited only by the merchants of the printing press and can reach 1000 fpm or higher.

Cured image will have sufficient chemical and abrasion resistance to meet most of the flexible packaging requirements. EB curable version of letterpress inks and possibly some UV compositions will have very low odor and extractables so they can meet all regulatory requirements, including FDA's. The whole process is simple, computer controlled and requires limited operator involvement. Such press and printing process can be used not only at the flexible packaging printing plant but at supermarket, department store, home center or any other place where needs in small amount of unique or personalized packaging may exist.

The invention has been described in terms of preferred embodiments thereof, but is more broadly applicable as will be understood by those skilled in the art. The scope of the invention is only limited by the following claims.

1. A digital printing process comprising
transferring energy curable paste inks from a digital printing plate onto a substrate by wet trapping, wherein said digital printing plate comprises
polymeric material covering the plate and
collapsed areas to form a non-image area on said plate, wherein said polymeric material contains at least 20% air by volume in the form of a foam.

2. The process of claim 1, wherein said polymeric material is selected from the group consisting of polyethylene, polypropylene, polystyrene, polyester, polyurethane, polycarbonate, polyvinyl chloride, epoxy, polyamide, polyisocyanurate, polyacrylics, rubber, melamine and a blend thereof.

3. The process of claim 1, wherein said polymeric material is temperature sensitive and reduces volume upon exposure to laser beam irradiation.

4. (canceled)

5. The process of claim 1, wherein said energy curable paste ink are UV or EB curable.

6. The process of claim 5, wherein said energy curable paste inks are actinic irradiation curable paste inks.
